(19) United States
(12) Patent Application Publication
(10) Pub. No.: US 2026/0292679 A1
(43) Pub. Date: Sep. 24, 2026

(54) Methods and Apparatuses for Supporting Internet of Things Device with Intermittent Receiver Activity

(71) Applicant: Telefonaktiebolaget LM Ericsson (publ), Stockholm (SE)

(72) Inventors: Bikramjit Singh, Raasepori (FI); Min Wang, Luleå (SE)

(21) Appl. No.: 19/168,502

(22) PCT Filed: Apr. 17, 2024
(86) PCT No.: PCT/SE2024/050373

§ 371 Date: Sep. 24, 2025

Related U.S. Application Data
(60) Provisional application No. 63/498,966, filed on Apr. 28, 2023.

(51) Int. Cl. H04W 52/02

(52) U.S. Cl. CPC H04W 52/0216

(57) ABSTRACT

According to some embodiments there is provided a method performed by a first assisting device for assisting communication between a first user equipment and a network node The method comprises receiving data from the network node intended for the first user equipment during a first time period during which the first user equipment is inactive. The method further comprises buffering the data until a second time period in which the first user equipment is active; and transmitting the data to the first user equipment during the second time period.

### TECHNICAL FIELD

Embodiments described herein relate to methods and apparatuses for supporting internet of things devices with intermittent receiver activity.

### BACKGROUND

### Ambient Internet of Things (IoT)

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billions of IoT devices for various applications and provide added value across the entire value chain. It may be considered undesirable to power all the IoT devices by a battery that needs to be replaced or recharged manually, as this would lead to high maintenance costs, serious environmental issues, and even safety hazards for some use cases, for example, wireless sensors in electrical power, and petroleum industries.

However, most of the existing wireless communication devices are powered by batteries that need to be replaced or recharged manually. The automation and digitization of various industries opens numerous new markets requiring new IoT technologies for supporting battery-less devices with no energy storage capability or devices with energy storage that does not need to be replaced or recharged manually.

An example type of application is asset identification, which presently resorts mainly to barcodes and Radio Frequency Identification (RFID) in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support a large-scale network with seamless coverage for RFID.

In light of above, 3rd Generation Partnership Project (3GPP) has defined a SI “Ambient IoT” in Release 18 to cover the scope and study relayed to such ultra-low power IoT devices which can be integrated into 3GPP networks. It is new and ongoing study and the document 3GPP, “Study on Ambient IoT (Internet of Things) in RAN (Release 18),” TR 38.848 V 0.0.2 (2022-12) briefly specifies information related to the feasibility of meeting the design targets for relevant use cases of a new 3GPP IoT technology, on the basis of suitable deployment scenarios in a 3GPP system, which relies on ultra-low complexity devices with ultra-low power consumption for very-low end IoT applications. It intends to provide a clear differentiation, i.e., addressing use cases and scenarios that cannot otherwise be fulfilled based on existing 3GPP Low Power Wide Area (LPWA) IoT technology.

In terms of energy storage, the study considers the following device characteristics: Pure battery-less devices with no energy storage capability at all, and completely dependent on the availability of an external source of energy; and Devices with limited energy storage capability that do not need to be replaced or recharged manually.

The study investigates the feasibility of a new IoT technology to open new markets within 3GPP systems, whose number of connections and/or device density can be orders of magnitude higher than existing 3GPP IoT technologies, and which can provide complexity and power consumption orders-of-magnitude lower than existing 3GPP Low Power Wide Area (LPWA) network technologies such as Narrow Band (NB)-IoT and Long Term Evolution (LTE)-Machine Type Communication (MTC).

Further it is important to remark that Ambient IoT 3GPP track as already agreed on utilizing relay or sidelink device or another UE for assisting an ambient IoT UE. Four topologies were agreed, out of which 3 topologies consider an assisting device which can be relay node and one For Further Study topology which also utilizes a relay node. See below agreements from RAN #98-e

“Topic 4-4: Connectivity topology

Agreement:
Topology (1): BS <-> Ambient IoT device
   NOTE 1: Includes the possibility of BS Rx and BS Tx in different BSs
Topology (2): BS <-> intermediate node <-> Ambient IoT device
   NOTE 1: Intermediate node can be relay, IAB, UE, repeater, etc. which is capable of ambient IoT
Topology (3): BS <-> assisting node <-> Ambient IoT device <-> BS
   NOTE 1: Assisting node can be relay, IAB, UE, repeater, etc. which is capable of ambient IoT
   FFS: If the two BS can be different
Topology (4): UE <-> Ambient IoT device
FFS: Topology (5) UE <-> Ambient IoT device <-> {BS or UE}NOTE: For potential topology (5), discuss its relation with other topologies, its necessity, etc. in RAN #99.

NOTE for all topologies: The Ambient IoT device may be provided with carrier wave from another node(s) either inside or outside the topology NOTE for all topologies: The links in each topology may be bidirectional or unidirectional FFS: Whether to consider combination of different topologies in the study.

FFS: BS, UE, or assisting node could be multiple BSs, UEs or assisting nodes, respectively.”

### SUMMARY

There currently exist certain challenge(s).

For a device supporting ambient IoT traffic, the device would have limitations regarding its power or energy storage. Presently, in TR 38.848 v 0.0.2, these limitations are defined as follows, and the detailed characteristics and features are currently being discussed in RAN Study Item.

In terms of energy storage, the study focusing on ambient IoT considers the following device characteristics:
Pure battery-less devices with no energy storage capability at all, and completely dependent on the availability of an external source of energy; and/or
Devices with limited energy storage capability that do not need to be replaced or recharged manually.

In the last meeting [RAN Ambient IoT SI, meeting #99] companies are discussing to have two classed of storage with lower capacity is barely few uJ or mJ [RP-230105, RP-230674, RP-230301]

“Task 5.4 Ultra-low power/cost device and communication designs (M4-M27), Lead: OUL22, Contrib.: AAU3, IMEC12, ORA21, LMF23, QLC26, SEQ28, WIN41, NXP43,Dependencies: BIE #1, D1.1, D3.2, D5.1; Outputs: D5.2, D5.3, D5.4, D5.5. Scope/goal: WPO5.4. Work in the task: This task will characterize/analyse the power consumption, cost (including manufacturing process, materials and their circularity), and performance trade-offs of low-power/cost 6G IoT devices3,12,26,28. It will design efficient zero-energy communication technologies, potentially relying on ultra-low power backscattering3,21, energy harvesting from ambient sources12,21,22 and/or dedicated RF energy transmitters22, energy-aware joint computing and communication12,43, onboarding/offloading computations with energy-awareness and sustainability criteria41,43, intelligent wake-up22 and tiny AI12,22,43 mechanisms. Protocol and signalling aspects and other considerations for enabling the communication with the ultra-low power devices in a 6G system will be analyzed 23,26. Finally, Component-PoC #C.4 will be developed, supporting new sustainable zero-energy IoT business cases for smart factory, smart logistics, smart metering and smart localisation3,21,41.”

If a IoT device is passive or semi-passive, this puts even tougher requirements than current 5G. These 6G IoT devices are either located close to the gNB or required with an assisting node to access the gNB as these IoT devices are not expected to have energy storage like 5G active IoT devices.

Hence, in embodiments described herein, scenarios are explored in which an assisting node can help to serve IoT devices (e.g., help to store data for the IoT device received from the network, or forward the data received from the IoT device to the network). Some embodiments focus on mechanisms which may include selection of an assisting device, discovery of an assisting device, energy cycle alignment an assisting device by an IoT device or a controlling node, e.g., gNB which is connected to IoT device and assisting node for Downlink (DL) transmissions.

The assistance aspect considers that, when IoT device is awake for brief period after it has harvested energy, then assisting device is able to provide DL transmissions to the IoT (that originated in the controlling node). This relieves pressure on controlling node otherwise it has to buffer transmissions and synch with one or more IoT devices that it is communicating with. This may not be issue if only one or few IoT device are communicating with the controlling node (e.g. in a cell), however, this can potentially become a problem, considering a scenario with 100s or 1000s of IoT tags/stickers (devices) in a warehouse which are receiving DL updates, for example from a single controlling node. In these circumstances, one or more assisting devices may be able to relieve pressure on the controlling node (e.g. reliving pressure on processing resources, required buffering, handling of extremely large Discontinuous Reception (DRX)/energy cycle related configurations, etc.) in serving DL traffic to IoT devices which are located close to one of the one or more assisting devices.

For the concerned scenarios, i.e., an IoT device transmits or receives data from the network involving one or multiple assisting devices in the procedure. The involvement may mean different aspects
1)One or multiple assisting devices help to relay the data received from the IoT device to the network
2)One or multiple assisting devices help to store received data from the network intended for the IoT device and forward the data to the IoT device when the IoT device is awake/has energy to receive data.

The following issues are addressed by embodiments described herein.
1) How to discover neighbor devices which are candidates for the assisting devices?
2) What are the criteria based on which the assisting devices can be selected and reselected?

3) How to align DRX/energy cycles between the IoT device and the assisting devices to achieve a good balance between the IoT device's energy constraint and the Quality of Service (QoS) requirements of the IoT device's employed services?

Certain aspects of the disclosure and their embodiments may provide solutions to these or other challenges.

Embodiments described herein utilize a first assisting node which may also be referred to as an Infrastructure Enable Device (IED) to assist network node (also referred to as a controller node), e.g., gNB in cell which is serving one or more user equipments (e.g. IoT devices). A first user equipment (e.g. IoT device) may have intermittent receiver activity, and therefore, the first assisting device may help the network node in buffering transmissions which are meant for first user equipment when first user equipment's receiver is inactive, and as a result, the load capacity can be increased. To assist the network node/first user equipment in using the first assisting device, we propose supporting mechanisms which include, discovery of the first assisting device, information exchange with the first assisting device, a transmission policy to the first assisting device, a termination policy with the first assisting device, etc. related assisting device based nodes.

Embodiments described herein introduce an Infrastructure Enabler Device (IED) (also referred to as an assisting device) and the related signaling, discovery, selection, and information sharing mechanisms to support a user equipment (e.g. IoT Device) with intermittent receiver (i.e., sometimes receiver is active and sometimes it is power off or down due to no energy in the circuitry). A network node (e.g. gNB) may transmit data to IED if the user equipment is not active, and once the user equipment is active (e.g. the receiver is powered ON), the IED may transmit the buffered data to the user equipment (e.g. IoT device).

According to some embodiments there is provided a method performed by a first assisting device for assisting communication between a first user equipment and a network node. The method comprises receiving data from the network node intended for the first user equipment during a first time period during which the first user equipment is inactive. The method further comprises buffering the data until a second time period in which the first user equipment is active; and transmitting the data to the first user equipment during the second time period.

According to some embodiments there is provided a method performed by a first user equipment for communicating with a network node utilizing a first assisting device. The method comprises receiving data from the first assisting device during a second time period in which the first user equipment is active, wherein the data was transmitted from the network node to the first assisting device during a first time period in which the first user equipment is inactive.

According to some embodiments there is provided a method performed by a network node for communicating with a first user equipment using a first assisting device. The method comprises transmitting data, to the first assisting device, intended for the first user equipment during a first time period during which the first user equipment is inactive.

According to some embodiments there is provided a first assisting device for assisting communication between a first user equipment and a network node. The first assisting device comprises processing circuitry and memory, the memory containing instructions executable by the processing circuitry whereby the first assisting device is operable to: receive data from the network node intended for the first user equipment during a first time period during which the first user equipment is inactive; buffer the data until a second time period in which the first user equipment is active; and transmit the data to the first user equipment during the second time period.

According to some embodiments there is provided a first user equipment for communicating with a network node utilizing a first assisting device. The first user equipment comprises processing circuitry and memory, the memory containing instructions executable by the processing circuitry whereby the first user equipment is operable to: receive data from the first assisting device during a second time period in which the first user equipment is active, wherein the data was transmitted from the network node to the first assisting device during a first time period in which the first user equipment is inactive.

According to some embodiments there is provided a network node for communicating with a first user equipment using a first assisting device. The network node comprising processing circuitry and memory, the memory containing instructions executable by the processing circuitry whereby the network node is operable to: transmit data, to the first assisting device, intended for the first user equipment during a first time period during which the first user equipment is inactive.

According to some embodiments there is provided a computer program, comprising instructions which, when executed on at least one processor, cause the at least one processor to carry out any of the methods described above.

According to some embodiments there is provided a computer-readable medium comprising instructions that, when executed on at least one processor, cause the at least one processor to perform any of the methods described above.

According to some embodiments there is provided a computer program product comprising non transitory computer readable media having stored thereon a computer program as described above.

Certain embodiments may provide one or more of the following technical advantage(s).

An advantage of embodiments described herein in the enabling of serving of extremely large number of IoT devices (e.g. tags) in a given geographic area. Imagine a warehouse with 1000s of products with IT tags pasted on the boxes, the network would be overburdened with serving all the IoT tags at the same time given that these IoT tags will be active for a brief period. Hence, if surrounding devices (e.g. IEDs) can assist the IoT tags, then these IoT tags can be served with ease. Hence, in essence, utilization of IEDs can increase the load capacity.

In addition, the most suitable neighbor devices can be selected and reselected for a given IoT device.

Discontinuous reception (DRX)/energy cycles may be well aligned between the user equipment (e.g. IoT device) and the assisting device to achieve a good balance between the user equipment's energy constraints and the Quality of Service (QoS) requirements of the user equipment's employed services.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a flow chart illustrating a method in accordance with some embodiments;

FIG. 2 is a flow chart illustrating a method in accordance with some embodiments;

FIG. 3 is a flow chart illustrating a method in accordance with some embodiments;

FIG. 4 is a signaling diagram illustrating an example implementation of the methods of FIGS. 1 to 3; FIG. 5 illustrates an example of an alignment between the first time period and second time period of the first user equipment and an energy cycle of the first assisting device;

FIG. 6 illustrates an example of an alignment between the first time period and second time period of the first user equipment and an energy cycle of the first assisting device;

FIG. 7 illustrates an example of an alignment between the first time period and second time period of the first user equipment and an energy cycle of the first assisting device;

FIG. 8 illustrates an example of an alignment between the first time period and second time period of the first user equipment and an energy cycle of the first assisting device;

FIG. 9 illustrates an example of an alignment between the first time period and second time period of the first user equipment and an energy cycle of the first assisting device;

FIG. 10 illustrates an example of an alignment between the first time period and second time period of the first user equipment and an energy cycle of the first assisting device;

FIG. 11 illustrates an example of an alignment between the first time period and second time period of the first user equipment and an energy cycle of the first assisting device;

FIG. 12 illustrates an example of an alignment between the first time period and second time period of the first user equipment and an energy cycle of the first assisting device;

FIG. 13 illustrates an example of an alignment between the first time period and second time period of the first user equipment and an energy cycle of the first assisting device;

FIG. 14 illustrates an example configuration of SPS resources;

FIG. 15 illustrates an example configuration of SPS resources;

FIG. 16 shows an example of a communication system in accordance with some embodiments;

FIG. 17 shows a UE in accordance with some embodiments;

FIG. 18 shows a network node in accordance with some embodiments;

FIG. 19 is a block diagram illustrating a virtualization environment in which functions implemented by some embodiments may be virtualized.

### DETAILED DESCRIPTION

Some of the embodiments contemplated herein will now be described more fully with reference to the accompanying drawings. Embodiments are provided by way of example to convey the scope of the subject matter to those skilled in the art.

The infrastructure enabler device (IED) may be addressed with different terminologies, such as assisting node or device, friend node or device, intermediate node or device, etc.

The assisting node may comprise av relay node, a repeater node, a base station (e.g. gNB), an Integrated Access and Backhaul (IAB) node, a user equipment (UE), etc. It will be appreciated that embodiments may be applied to any type of assisting node, and not restrict to an assisting node with a specific capability (e.g., just relay node based IED or repeater based IED, as an example).

In examples in which the assisting device is considered a relay node, then the relay node can also be simply described as UE (see agreed topologies in problem statement), and the link between UE (assisting device) and the ambient IoT device can be described as relay link or new link/interface where below embodiments can be applied in a non-limiting manner. However, for the discussion, we will use relay node terminology, and link with ambient IoT device as relay link.

The assisting device may comprise any type of UE capable of providing relay functions based on any device to device communication technologies including SL, Wifi, Bluetooth, etc., gNB, IAB, etc. and we do not focus on particular type herein. However, implementing the assisting device as relay, e.g. a UE, may be considered a more viable scenario given that gNB/IAB densification can be expensive.

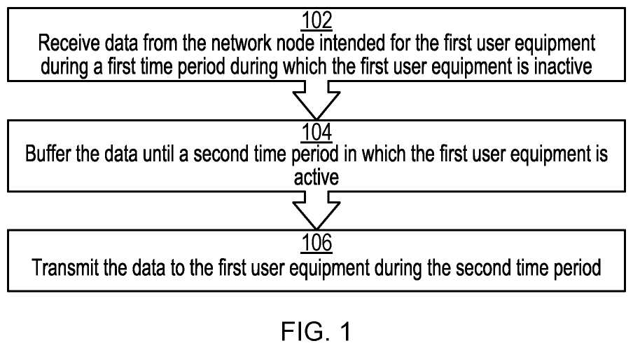

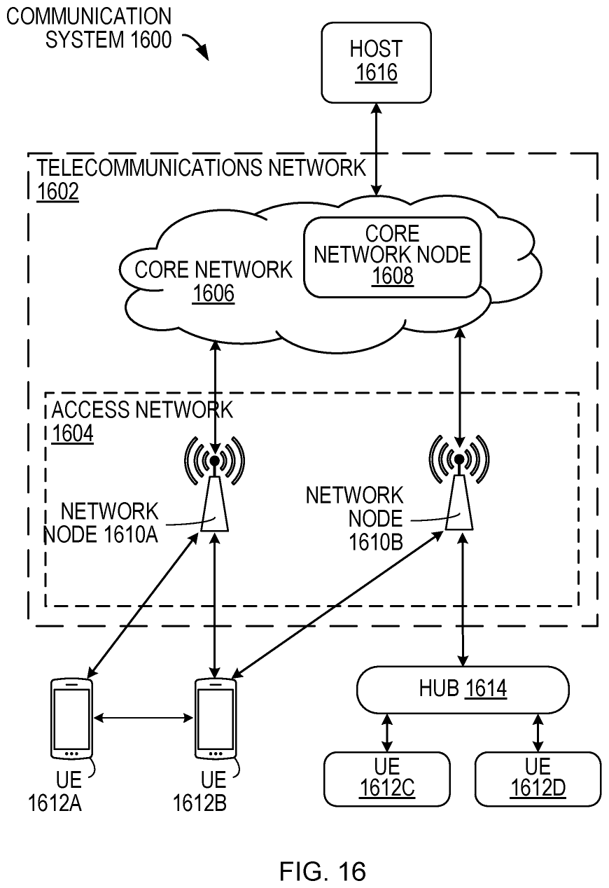

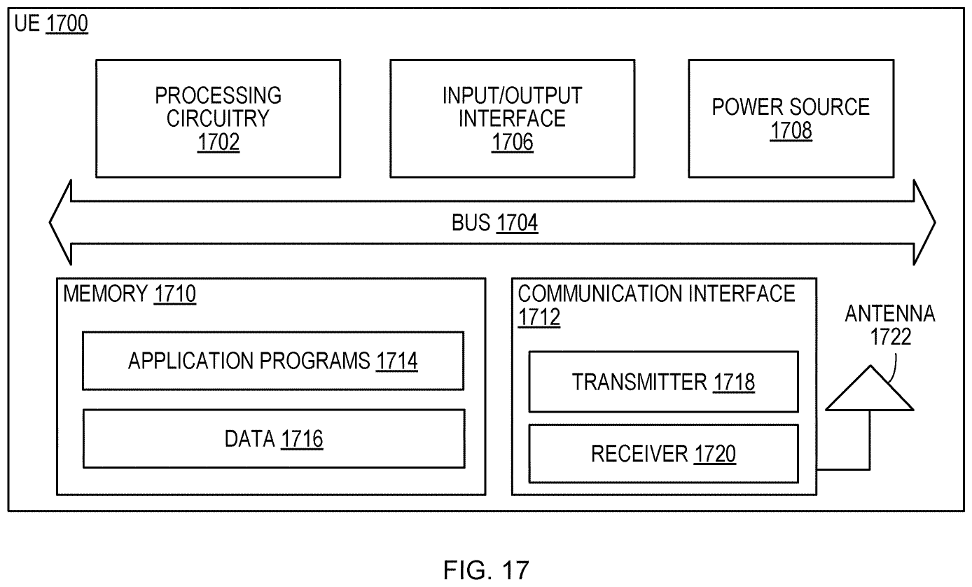

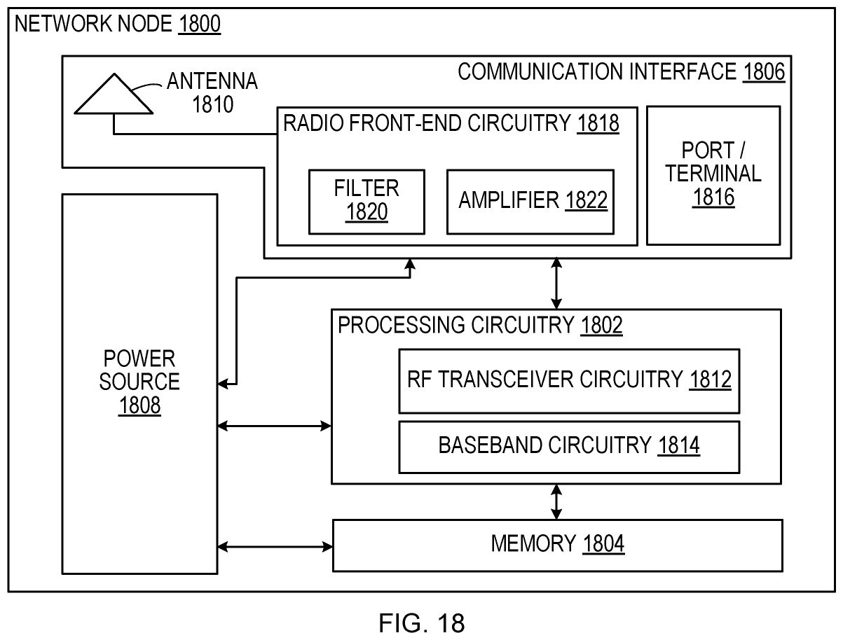

FIG. 1 illustrates a method in accordance with particular embodiments. It will be appreciated that the method of FIG. 1 may be performed by any suitable first assisting device (e.g. IED). The method may be performed to enable a first user equipment to communicate with a network node utilizing the first assisting device. The first assisting device performing the method of FIG. 1 may comprise a UE or wireless device (e.g. the UE 1612 or UE 1700 as described later with reference to FIGS. 16 and 17 respectively) or a network node (e.g. the network node 1610 or network node 1800 as described later with reference to FIGS. 16 and 18 respectively). The method begins at step 102 with receiving data from the network node intended for the first user equipment during a first time period during which the first user equipment is inactive. In step 104 the method comprises buffering the data until a second time period in which the first user equipment is active. In step 106 the method comprises transmitting the data to the first user equipment during the second time period.

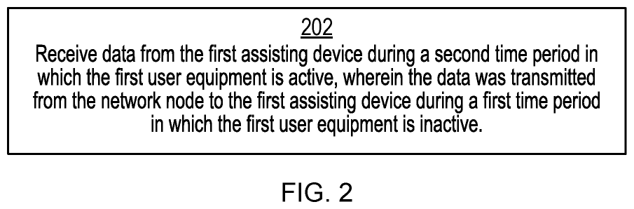

FIG. 2 illustrates a method in accordance with particular embodiments. The method of FIG. 2 may be performed by a first user equipment (UE) or wireless device (e.g. the UE 1612 or UE 1700 as described later with reference to FIGS. 16 and 17 respectively). The method may be performed to enable the first user equipment to communicate with a network node utilizing a first assisting device. The method begins at step 202 with receiving data from the first assisting device during a second time period in which the first user equipment is active, wherein the data was transmitted from the network node to the first assisting device during a first time period in which the first user equipment is inactive.

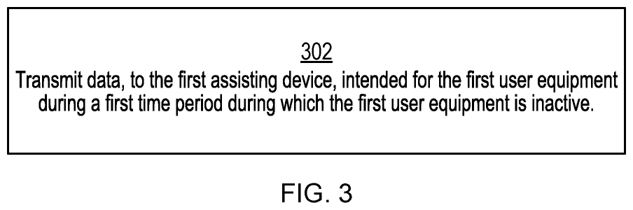

FIG. 3 illustrates a method in accordance with particular embodiments. The method of FIG. 3 may be performed by a network node (e.g. the network node 1610 or network node 1800 as described later with reference to FIGS. 16 and 18 respectively). The method may be performed to enable a first user equipment to communicate with the network node utilizing a first assisting device. The method begins at step 302 with transmitting data, to the first assisting device, intended for the first user equipment during a first time period during which the first user equipment is inactive.

Although herein the described embodiments focus on scenarios in which the network node comprises a base station (e.g. a gNB), it will be appreciated that the network node may comprise other types of network node, for example.

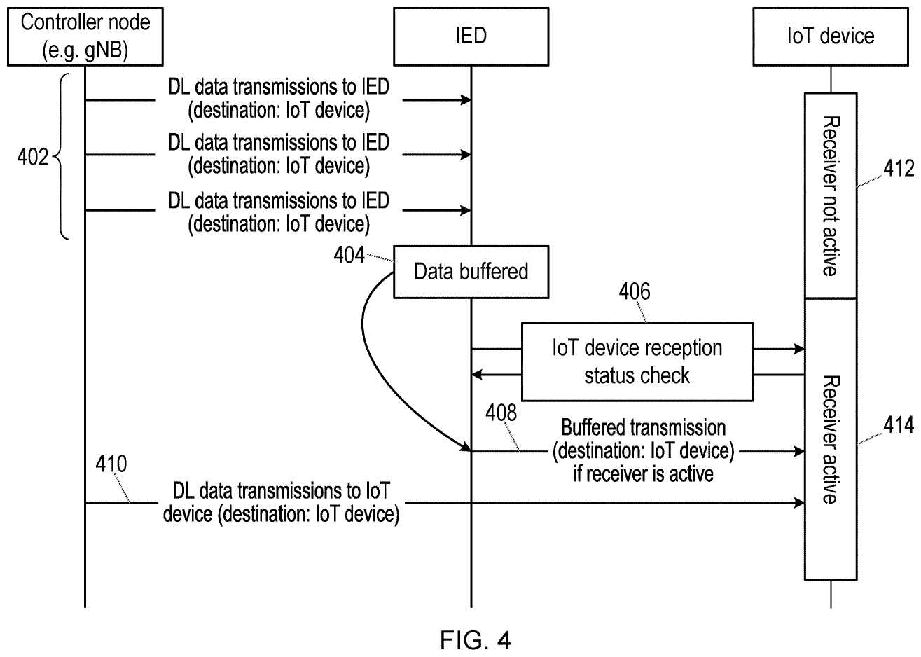

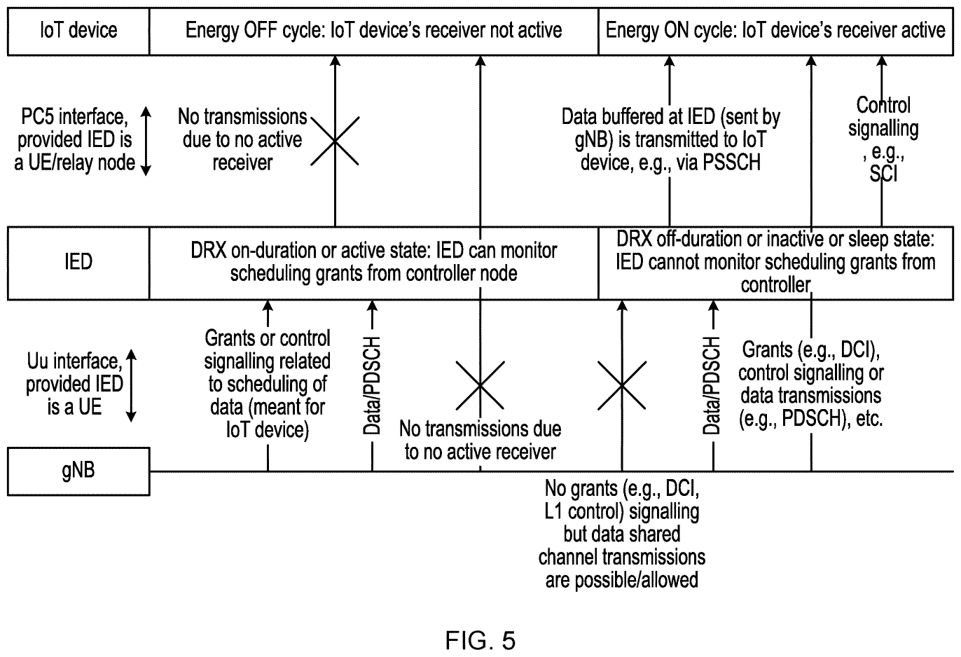

FIG. 4 illustrates an example implementation of the methods of FIGS. 1, 2 and 3 according to some embodiments.

In FIG. 4 the first assisting device is referred to as an IED and the first user equipment comprises an IoT device. It will be appreciated that embodiments described herein referring to an IED may be equally applied to any type of assisting device. Similarly, any embodiments described herein referring to an IoT device may be applied to any type of first user equipment.

As illustrated in FIG. 4, the first assisting device assists a nearby first user equipment with intermittent receiver (e.g., ambient IoT, or ultra-low power device) by buffering 404 its transmissions (meant for the first user equipment) which is transmitted by some master/controlling node (e.g., master gNB) during first user equipment's device sleep mode, no active mode, or disconnected mode 412 (it means the first user equipment is drained of energy, and the energy being harvested or accumulated is not enough yet to power the first user equipment's device circuitry or there is not enough power yet to activate receiver, etc.).

The first assisting device may provide the assistance to the first user equipment based on information/knowledge of active states and energy status of its own and the first user equipment.

Once, the first user equipment is active or connected to the network or have enough energy to activate receiver, then the first assisting device and first user equipment can exchange information/signaling and enable the transmission of buffered transmissions/data from the first assisting device to the first user equipment. Note, the first assisting device may be a gNB, relay node, or some new node type, and thus transmissions are mapped according to the interface between first assisting device and first user equipment. For instance, if the first assisting device is gNB, the transmission is sent over DL data shared channels over Uu interface, or if first assisting device is a device supporting sidelink (SL) relay, then the transmission is sent over Sidelink (SL) shared channel over PC5 interface.

In step 402 the network node transmits DL data transmissions to the first assisting device that are intended for the first user equipment during the first time period 412 in which the IoT device is inactive (e.g. sleep mode, inactive mode, or disconnected mode). The inactive mode may comprise any mode in which the first user equipment's receiver is unable to receive transmissions. Step 404 comprises an example implementation of steps 102 and 302.

In step 404 the first assisting device buffers the received data until the first user equipment is in an active mode. Step 404 comprises an example implementation of step 104.

In step 406 the first assisting device checks that the first user equipment is capable of receiving transmissions. In other words, the first assisting device checks whether the first user equipment has entered into a second time period in which the first user equipment is active (e.g. the receiver is capable of receiving transmissions).

In step 408 the first assisting device (e.g. responsive to determining that the first user equipment is active in step 406) transmits the buffered data to the first user equipment. Step 408 comprises an example implementation of steps 106 and 202.

The energy cycle of the first user equipment (e.g. the first time period and/or the second time period) may be configured by the assisting device or generated by the first user equipment itself, for example, if the first user equipment has no network coverage. In examples where the first user equipment has network coverage, the energy cycle may be configured by the network node.

It will also be appreciated that during the second time period the first user equipment is also able to receive DL transmissions from the network node as illustrated in step 410. In other words, if the first user equipment is active, then it can receive data directly form master/controller node and first assisting device (buffered transmissions came from master/controller node) as well. In some embodiments, a restriction may be applied, such that, if the network node is transmitting to first user equipment device, then first assisting device may not be allowed to transmit to first user equipment or vice-versa, e.g., due to orthogonal time resource sharing between controller node and first assisting device. In other examples, both the network node and first assisting device may transmit to the first user equipment at the same time but may use different carriers/cells/Bandwidth parts (BWPs) to first user equipment.

In one embodiment, the first user equipment may indicate, to the network node and/or the first assisting device its receiver activity cycles. In other words, it indicates, energy charging/discharging information or cycles. The energy charging/discharging information may comprise an indication of how much time first user equipment takes to harvest energy (during that time, receiver may not be active) and how long the harvested energy can last long (during the time, receiver can be made active. Note, if the receiver of the first user equipment is active, the first user equipment may still harvest energy. The first user equipment may indicate its receiver activity information to the network node and/or the first assisting device. In other words, the method of FIG. 2 may comprise transmitting an indication of the first time period and/or the second time period to the first assisting device or the network node.

The indication of the first time period and/or second time period may comprise a periodicity or an indication of periodic cycles related charging or discharging, a length of charging/discharging period, and possible deviations in the periodicity and length. The first user equipment may indicate other parameters along with the indication of the first time period and/or second time period, which may be a function of harvesting/charging/discharging/receiver activity related information. For instance, the first user equipment may indicate a bitmap of slots or symbols where first user equipment may receive transmissions (DL from controller node, buffered transmission from first assisting device, etc.) In one option, the first user equipment indicates a discontinuous reception (DRX) cycle where the DRX cycle is based on the first user equipment's receiver activity or harvesting/charging/discharging cycle. This information exchanged between the first user equipment and the first assisting device may be referred to as assistance information, which aims for at least one of the following purposes:
1) Boosting selection and reselection of the assisting devices
2) Aligning an active status of the first user equipment with an energy cycle of the first assisting device

The first assisting device for a given first user equipment may be selected by the network node or by the first user equipment. In some examples, the first assisting device may be selected or configured if it indicates or has one or more of the following characteristics:
the first assisting device has indicated to the network node that it has the capability to provide assistance;
the first assisting device has low mobility;
the first assisting device is located in close proximity to the first user equipment,
   For example, a neighbor device which is closest to the first user equipment may be selected as an assisting device
   For example, a neighbor device which has a strongest radio channel quality with the first user equipment may be selected as the first assisting device;
the first assisting device has a sufficient data buffering capacity to operate as an assisting device
the first assisting device is not fully occupied, e.g. it is able to provide assistance to the first user equipment. For example, the first assisting device may be connected to few other or no other user equipments, and thus, it may serve an additional user equipment; and
the first assisting device has a constant or reliable power supply from the grid or a long battery life.

The network node may be made aware if a neighboring device may be used as an assisting device for another user equipment. The related capability information of the neighbor device can be indicated to network node by the neighbor device. The network node may share the IED information (i.e., which of its UEs in its cells can act as assisting devices) to other network nodes. For instance, if the network node is a gNB, this IED information may be shared over X2 interface between gNBs, or during handovers, etc. Other network nodes may utilize this information to help IoT devices in their cells to use assisting devices even though the candidate assisting devices are connected to different cells/network node. This is because, an assisting device will typically connect to strongest cell (minimal path loss), e. g a primary network node, but this does not necessarily mean other cells or network nodes will have poor link to such assisting devices. As long as the link quality can be maintained (i.e., above threshold quality w.r.t. other network nodes), other network nodes may transmit their transmissions (DL transmissions from other gNBs) to this assisting device which can then buffer the data and transmit it later to user equipments belonging to other cells/network nodes/gNBs.

In one embodiment, if an assisting device (connected/attached to some IoT device for assistance is transmitting its buffered transmission) moves away from its current location towards different cell sector, different cell, etc., it can indicate that it can no longer serve as assisting device to the given user equipment (let's name this indication as end of relationship (EOR)) using some signaling (e.g., Layer 1 (L1), Layer 2 (L2), Radio Resource Control (RRC) based) to the user equipment or network node or both. For example, the method of FIG. 1 may comprise, responsive to the first assisting device moving to a location that does not meet a first criterion (e.g. the distance to the first user equipment is greater than a first predetermined threshold or the link quality with the first user equipment has dropped below a second predetermined threshold), the first assisting device may transmit an indication to the first user equipment or the network node that the first assisting device can no longer provide assistance to the first user equipment. If the network node receives this indication it may forward the indication to the first user equipment.

In another option, the first user equipment or network node may send EOR indication to the first assisting device for its connection with a given first user equipment, which means the first assisting device can no longer serve this first user equipment by transmitting the buffered transmissions to the first user equipment. For example, the method of FIG. 1 may comprise responsive to receiving an indication from the first user equipment or the network node that the first assisting device can no longer provide assistance to the first user equipment, the first assisting device may cease communication with the first user equipment.

In one embodiment, if the first user equipment finds a better assisting device, then the first user equipment may transmit EOR signaling to the first assisting device and may proceed to connected or transmit a start of relationship (SOR) with a second assisting device.

For example, the method of FIG. 2 may comprise, responsive to determining that a second assisting device is to be used, transmitting an indication to the first assisting device or the network node that the first assisting device can no longer provide assistance to the first user equipment. The method of FIG. 2 may then further comprise responsive to determining that a second assisting device is to be used, initiating a connection with the second assisting device. It will be appreciated that the first user equipment may determine that a second assisting device is to be used if a second assisting device is found that, for example: has a better link quality than that of the first assisting device; and/or is closer to the first user equipment than the first assisting device.

In above embodiments, the signaling related to EOR or SOR may be exchanged directly between first user equipment and the first assisting device and/or second assisting device. In other examples, the signaling related to EOR and SOR may be transmitted or via the network node (e.g., gNB). In some examples, the network node may indicate EOR or SOR to the first assisting device where the network node may or may not have received an indication/preference/recommendation from the first user equipment regarding the first assisting device.

In one embodiment, the first assisting device may select its or be configured (by the network node) with one or multiple energy cycles (e.g. DRX cycles), which are partly, nearly or fully aligned with first user equipment's energy charging/discharging/harvesting/DRX cycles (from onwards, we label all these parameters under single parameter of energy cycle). In other words, the method of FIG. 1 may comprise the first assisting node selecting an energy cycle of the assisting device based on the indication of the first time period and/or the second time period. Alternatively, the method of FIG. 1 may comprise the first assisting device receiving a configuration for an energy cycle from the network node.

A DRX cycle may comprise at least one ON-Duration (active state/cycle) and one OFF-Duration (inactive state/sleep cycle). During each ON-Duration, the first assisting device is in active state for monitoring or receiving control information on one or multiple concerned radio links/connections. During each OFF-Duration, the device is in inactive state for monitoring or receiving the control information on one or multiple concerned radio links/connections.

In one option, the selecting and setting of a DRX cycle at the first assisting device is primarily done by exchanging signaling between the first assisting device and the network node. In order to do this, it may be desirable that the first user equipment has indicated its energy cycles (e.g. the first time period and/or the second time period) to the network node so that the network node can configure the DRX cycles at the first assisting device appropriately (e.g. for proper alignment with the active and inactive periods at the first user equipment). The network node or first assisting device may indicate the first assisting devices energy (e.g. DRX) cycle related information to the first user equipment.

In one option the selecting and setting of an energy (e.g. DRX) cycle at the first assisting device may be performed by exchanging signaling between the first assisting device and the first user equipment. Once, the DRX cycle is selected, the first assisting device may indicate the DRX cycle to the network node (this may be considered an autonomous choice as network node in this case has little to no say in the first assisting devices DRX cycle selection).

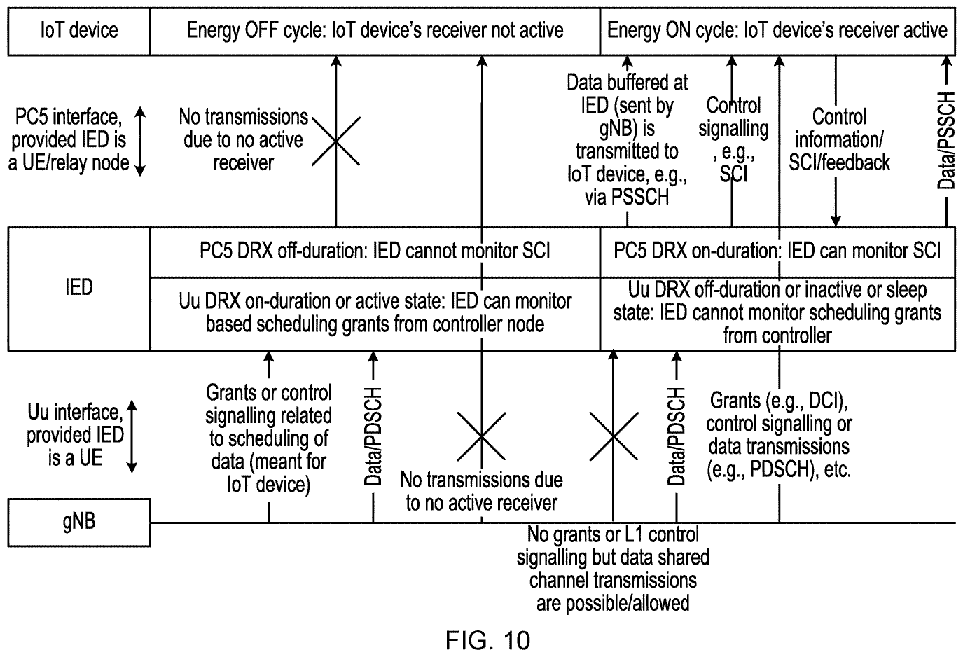

How the DRX cycle of the first assisting device is aligned with the first time period and second time period in the first user equipment may depend on what type of control information the first assisting device expects to receive from the first ser equipment and/or the network node. Note, there may be two DRX configurations set up at the first user equipment (as illustrated in FIGS. 10 to 13), one for receptions of transmissions (typically control signaling)) coming from the network node and another for receptions of transmissions (typically control signaling) coming from the first user equipment (e.g., N/ACK feedback transmission to the first assisting device by the first user equipment related to the buffered data transmissions from first assisting device to the first user equipment). In other examples (e.g. as illustrated in FIGS. 5 to 9), there may be a common DRX configuration, for receptions of transmissions coming from the network node and the first user equipment.

How to achieve alignment between a DRX cycle of the first assisting device and the first time period and the second time period of the first user equipment may be different in different cases.

In some cases, the energy cycle of the first assisting device comprises an ACTIVE state during the first time period (e.g. when the first user equipment is in an INACTIVE state), meanwhile, the energy cycle of the first assisting device may comprise an INACTIVE state during at least part of the second time period (e.g. when the first user equipment is in an ACTIVE state). Such alignment may be needed as the first user equipment has lower/limited power/energy and, therefore, the first user equipment has to harvest/be charged from time to time. The first user equipment may have no need to be always involved in helping the first user equipment to receive data/transmission from the network node. Such an alignment may be beneficial to improve energy saving for both the first user equipment and the first assisting device.

FIG. 5 illustrates an example of an alignment between the first time period and second time period of the first user equipment and an energy cycle of the first assisting device. In this example, the inactive state/cycle at the first assisting device (during which the first assisting device does not monitor control information) matches the second time period (e.g. energy ON —receiver is active) of the first user equipment. This is because, when first user equipment's receiver is OFF/not active (e.g. during the first time period), then first user equipment cannot receive data transmissions from the network node directly, hence during those times, the first assisting device is in an active DRX state (i.e., it has valid onDurationTimer and drx-InactivityTimer), so that it can monitor control information (e.g., Downlink Control Information (DCI)) from the network node (e.g., gNB) related to scheduling of data transmissions at the first assisting device where the data (transmissions) are meant for (destined to) the first user equipment. When the first assisting device has a DRX inactive state, it cannot monitor any scheduling grants or L1 control information from the network node, however, the network node can send any data directly to the first user equipment, as during period, IoT device has an active receiver (second time period) and hence there may not be a need for the first assisting device to monitor grants/control information from the network node. It will be appreciated that even when the first assisting device is in a DRX inactive state cycle, it may still transmit the buffered data transmissions to first user equipment. It will also be appreciated that even when the first assisting device is in a DRX inactive state cycle, it may still receive downlink data (e.g. Physical Downlink Shared Channel (PDSCH) data) from the network node than may be intended for the first assisting device or intended for the first user equipment.

In some examples, the alignment between the first assisting devices DRX cycle and the first time period and the second time period may be configured such that the first assisting devices DRX active cycle and second time period has some overlap in case the first assisting device requires some monitoring of control information transmitted from the first user equipment to the first assisting device. For example, the energy cycle of the first assisting device may comprise an active state for at least part of the second time period.

The control information can be related to L1 feedbacks of buffered data transmissions or requests from the first user equipment for its transmission request, etc.

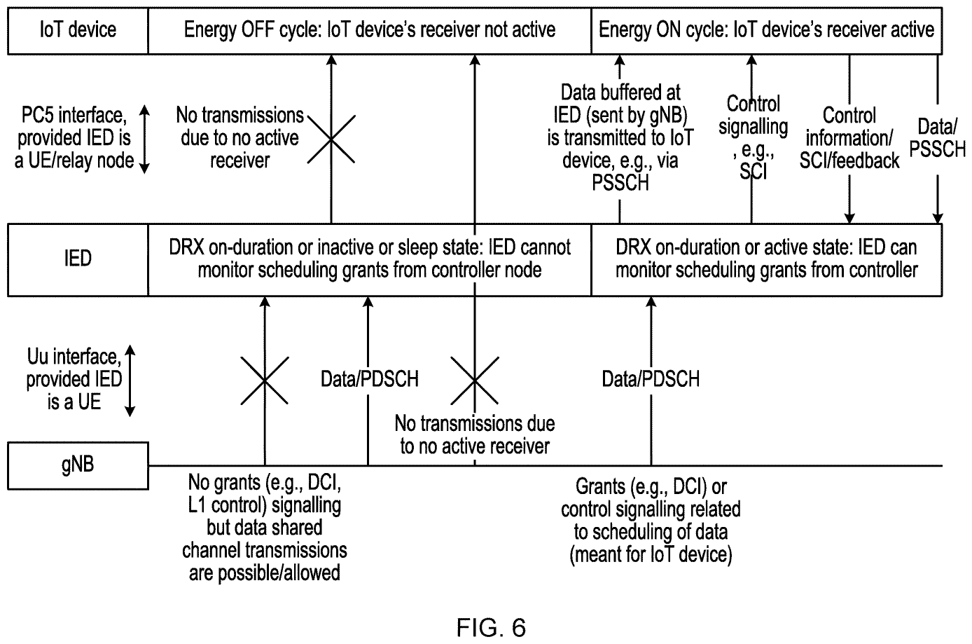

FIG. 6 illustrates an example of an alignment between the first time period and second time period of the first user equipment and an energy cycle of the first assisting device. In this example, the first assisting device energy cycle has an ACTIVE state aligned the second time period (e.g. the ACTIVE state of the first user equipment), meanwhile, the first assisting device's energy cycle has an INACTIVE state aligned with the first time period (e.g. the INACTIVE state of the first user equipment). Such alignment may be needed if the IoT device has lower/limited power/energy. It will be appreciated that the first user equipment may consume more energy if the first user equipment attempts to receive data directly from the network node as the direct connection between the first user equipment and the network node may be weak. In addition, the first user equipment may need to retain multiple reception configurations to communicate with both the first assisting device and the network node, one reception configuration for the first assisting device as a transmitter, and another reception configuration for the network node (gNB) as a transmitter. Instead, it would consume less energy if the first user equipment attempts to receive the data from the network node via the first assisting device.

As illustrated in FIG. 6, the first assisting device may buffer DL data (e.g. PDSCH) received during its inactive state that are intended for the first user equipment.

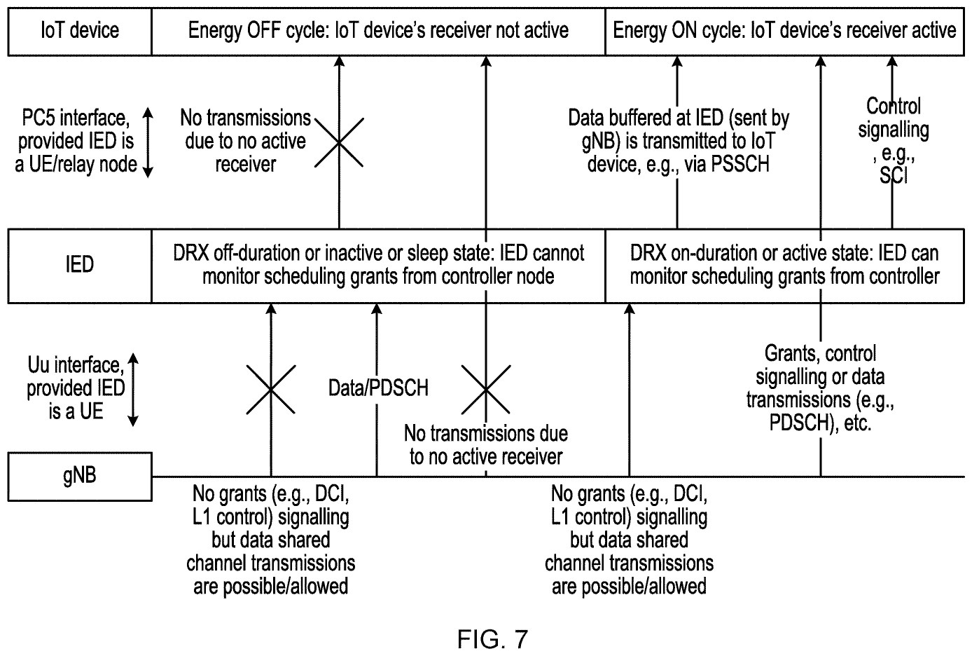

FIG. 7 illustrates an example of an alignment between the first time period and second time period of the first user equipment and an energy cycle of the first assisting device. In particular, FIG. 7 illustrates that there may be options for allowing grants or data reception directly from the network node gNB, in case the network node has a very high transmission power (e.g., macro cells) in addition from transmissions from the first assisting device to IoT device.

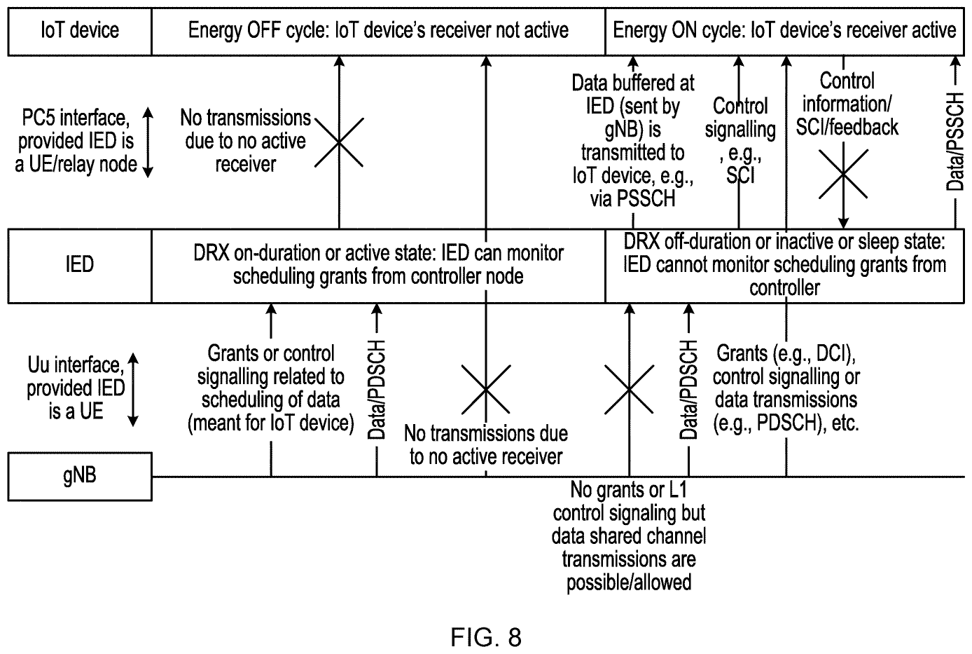

FIGS. 8 to 13 illustrate more possible alignment scenarios with one or more DRX configurations at the first assisting device related to Uu and PC5 interface.

FIG. 8 illustrates an example of an alignment between the first time period and second time period of the first user equipment and an energy cycle of the first assisting device.

Note: feedback can also be delivered to gNB directly if it is not possible to deliver to first assisting device

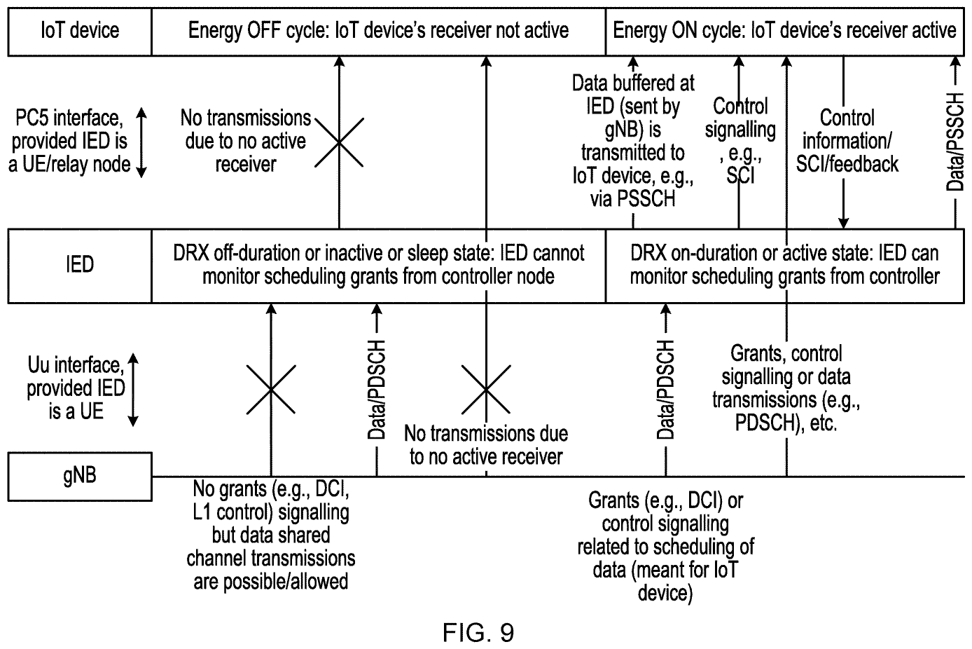

FIG. 9 illustrates an example of an alignment between the first time period and second time period of the first user equipment and an energy cycle of the first assisting device.

Note: feedback can also be delivered to network node directly or via first assisting device

FIG. 10 illustrates an example of an alignment between the first time period and second time period of the first user equipment and two energy cycles of the first assisting device.

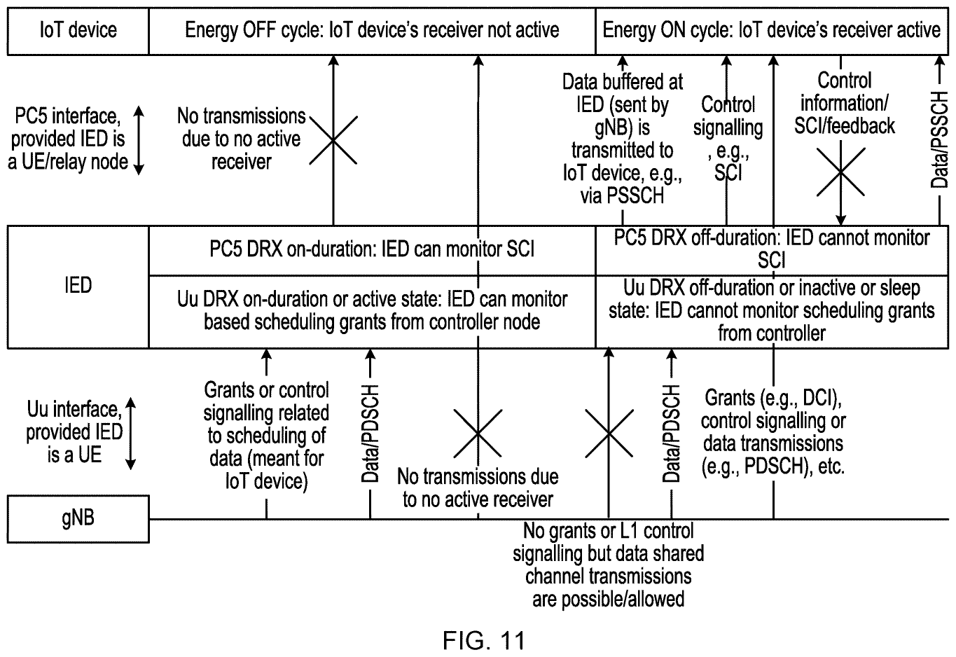

FIG. 11 illustrates an example of an alignment between the first time period and second time period of the first user equipment and two energy cycles of the first assisting device.

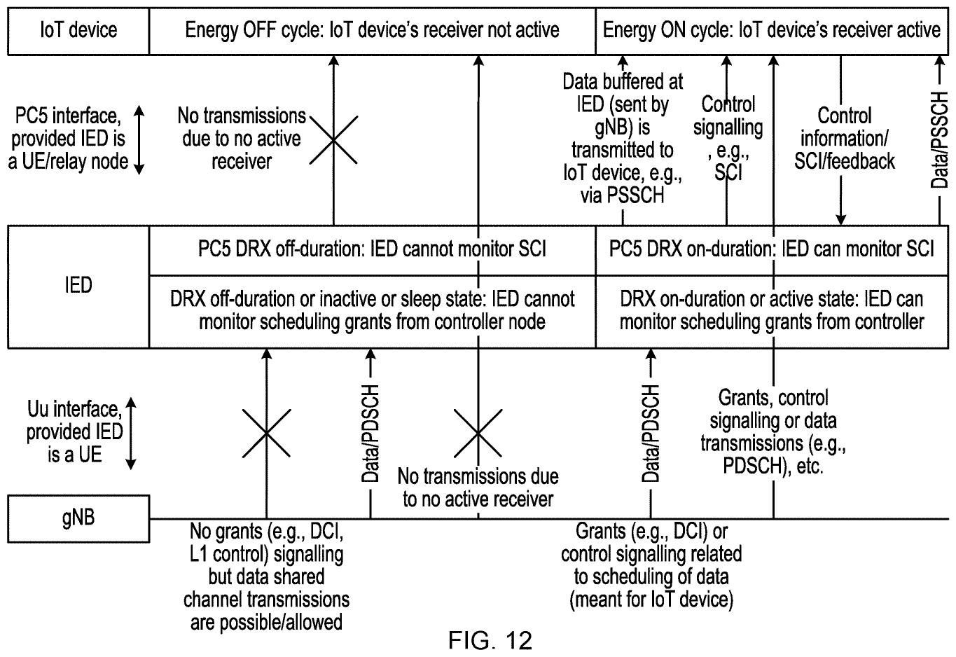

FIG. 12 illustrates an example of an alignment between the first time period and second time period of the first user equipment and two energy cycles of the first assisting device.

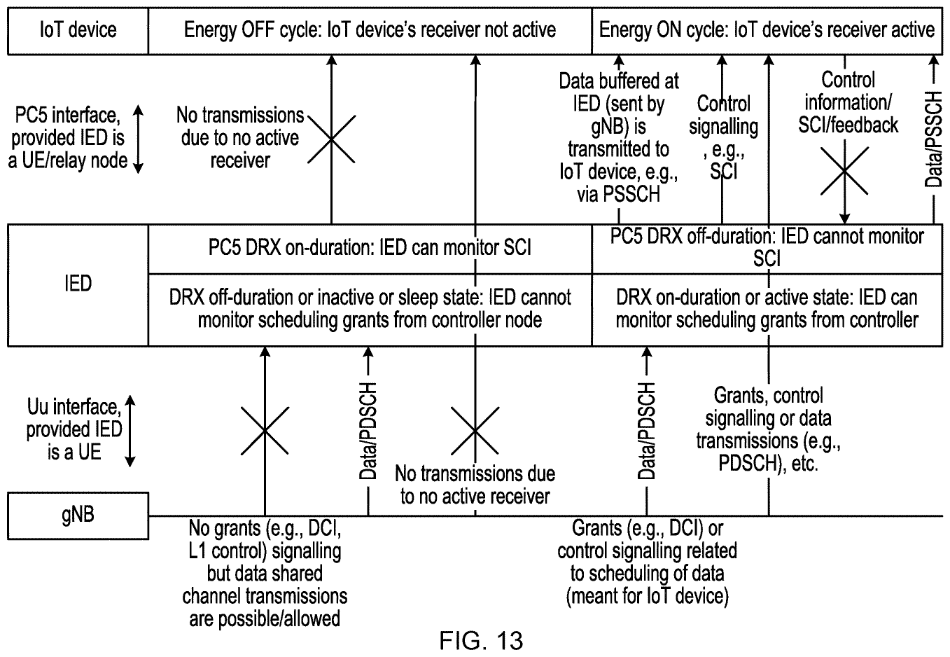

FIG. 13 illustrates an example of an alignment between the first time period and second time period of the first user equipment and two energy cycles of the first assisting device.

In some examples, to discover or rediscover the first assisting device, the first user equipment broadcasts/multicasts/groupcasts a request for requiring or needing an assisting device's assistance in supporting its receptions. For example, the first user equipment may transmit a request for assistance in communicating with the network node to the network node and/or one or more candidate assisting devices.

The nearby assisting devices (e.g. the one or more candidate assisting devices) if they receive the request may subsequently respond to the request with an acknowledgement (ACK), and some additional parameters, e.g., location, link quality, IED ID, etc. In other words, responsive to transmitting the request, the first user equipment may receive, for each of the one or more candidate assisting devices, information comprising one or more of: a location of the candidate assisting device, a link quality between the candidate assisting device and the first user equipment, an identification of the candidate assisting device. In some examples, the above information for the one or more candidate assisting devices may be provided to the first user equipment by the network node.

The request transmitted by the first user equipment may, for example, comprise at least one reference signal, which the candidate assisting device may measure to report the link quality in response.

Based on a chosen criterion, first user equipment may select one or more of the candidate assisting devices. The criteria could be, for instance minimal path loss, best link quality, compatible DRX cycles, low mobility, etc. (please see above embodiments for other criteria). In other words, the first user equipment may select the first assisting device from the one or more candidate assisting devices based on the information received in response to the request.

In one embodiment, instead of the first user equipment, the network node performs the procedure to select the first assisting device. In other words, the network node may broadcast/multicast/groupcast the request, and possibly information regarding the first user equipment for which an assisting device is requested, and the candidate assisting devices may respond to the request. The network node may then select one or more of the candidate assisting devices for a given first user equipment's assistance based on some criteria.

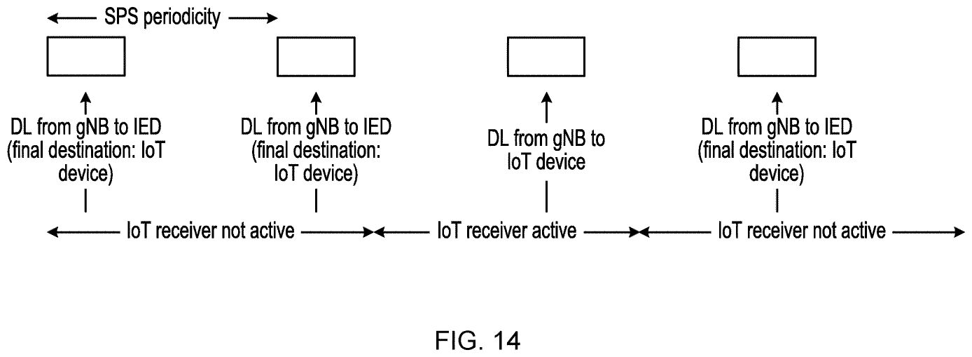

In some examples, the network node may configure common semi-persistent scheduling (SPS) resources for the first assisting device and the first user equipment for their receptions of the data which is destined to the first user equipment. For example, in FIG. 14, which illustrates an example configuration of SPS resources, if the first user equipment is active, then the SPS occasions may be used to transmit DL data from network node to the first user equipment directly, and if the first user equipment receiver is not active, then the SPS resource may be utilized by the first assisting device for DL transmissions (which will be buffered to then ultimately transmit to the first user equipment).

In one embodiment, an SPS resource can be configured for transmitting buffered data from the first assisting device to the first user equipment, e.g., if the interface is based on sidelink SL, then the SPS can be based on SL configured resources, see below figure where two SPS resource types are working in synch to implement a scheduling policy.

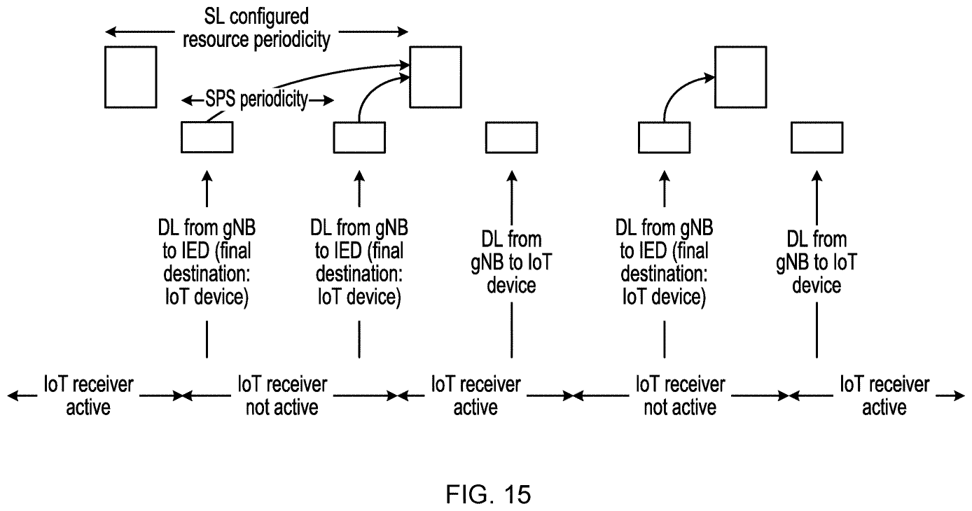

FIG. 15 illustrates an example configuration of SPS resources.

In FIG. 15, the data is received at the first assisting node from the network node during a first SPS resource type for transmissions from the network node. The data may then be transmitted to the first user equipment during a second SPS resource type for transmissions from the first assisting device to the first user equipment, wherein, in this example, the first SPS resource type does not overlap with the second SPS resource type.

In above embodiment, dynamic grants may be additionally utilized, however SPS may be preferred for firs user equipment because it is energy efficient solution as the first user equipment may need to monitor related downlink control information (DCIs) often. The SPS may be activated using one shot L1 signaling or Radio Resource Control (RRC) based signaling.

In some examples, a flexible retransmission scenario may be implemented. For instance, if the transmissions from first assisting device to the first user equipment fail, then the retransmissions may originate either from
the first assisting device itself or
the network node;
for example, subject to the first user equipment being ACTIVE or INACTIVE.

For the retransmissions, a feedback mechanism may be devised where the feedback of transmissions can occur from
first user equipment to first assisting device, and the first assisting device to the network node;
   This is useful, as the first assisting device may be allowed some attempt to retransmit data without engaging the network node to retransmit again, and if the time out and transmissions are not successful, then network node may retransmit the transmissions either to the first assisting device or the first user equipment, or
The first user equipment to the network node directly
   For transmissions transmitted from the network node to the first user equipment
   For the transmissions transmitted to first assisting device, which are then transmitted to the first user equipment by the first assisting device.

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3^{rd}Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1602 includes one or more Open-RAN (ORAN) network nodes. An ORAN network node is a node in the telecommunication network 1602 that supports an ORAN specification (e.g., a specification published by the O-RAN Alliance, or any similar organization) and may operate alone or together with other nodes to implement one or more functionalities of any node in the telecommunication network 1602, including one or more network nodes 1610 and/or core network nodes 1608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections. Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 16, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, a content source and analytics node, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular if one or more of the UEs are low energy IoT devices. The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs). The processing circuitry 1702 may be operable to provide, either alone or in conjunction with other UE 1700 components, such as the memory 1710, UE 1700 functionality. For example, the processing circuitry 1702 may be configured to cause the UE 1702 to perform the methods as described with reference to FIG. 1 or 2.

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems. The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In some embodiments, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes processing circuitry 1802, a memory 1804, a communication interface 1806, and a power source 1808, and/or any other component, or any combination thereof. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, network node 1800 functionality. For example, the processing circuitry 1802 may be configured to cause the network node to perform the methods as described with reference to FIG. 1 or 3.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

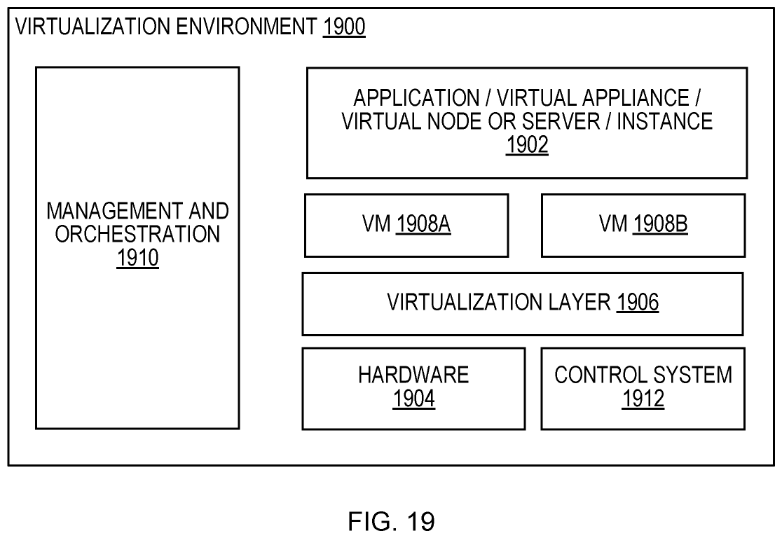

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1900 includes components defined by the O-RAN Alliance, such as an O-Cloud environment orchestrated by a Service Management and Orchestration Framework via an O-2 interface.

Applications 1902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a and 1908b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g. such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

EMBODIMENTS

### Group A1 Embodiments

1. A method performed by a first assisting device for assisting communication between a first user equipment and a network node, the method comprising:
   receiving data from the network node intended for the first user equipment during a first time period during which the first user equipment is inactive;
   buffering the data until a second time period in which the first user equipment is active; and
   transmitting the data to the first user equipment during the second time period.
2. The method of any previous embodiment, further comprising:
   receiving an indication of the first time period and/or the second time period from the first user equipment or the network node.
3. The method of any one of embodiments 2 further comprising selecting an energy cycle of the first assisting device based on the indication of the first time period and/or the second time period.
4. The method of embodiment 1 or 2 further comprising receiving a configuration for an energy cycle from the network node.
5. The method of embodiment 3 or 4 wherein the energy cycle comprises an active state during the first time period.
6. The method of embodiment 3 to 5 wherein energy cycle comprises an inactive state for at least part of the second time period.
7. The method of embodiment 6 wherein the energy cycle comprises an active state for at least part of the second time period.
8. The method of any previous embodiment, wherein the one or more of:
   the first assisting device has indicated to the network node that it has the capability to provide assistance;
   the first assisting device has low mobility;
   the first assisting device is located in close proximity to the user equipment;
   the first assisting device has a sufficient data buffering capacity to operate as an assisting device
   the first assisting device is not fully occupied; and
   the first assisting device has a constant or reliable power supply from the grid or a long battery life
9. The method of any previous embodiment, wherein the data is received from the network node during a first semi-persistent scheduling, SPS, resource type for transmissions from the network node.
10. The method of any previous embodiment, wherein the data is transmitted to the first user equipment during a second SPS resource type for transmissions from the first assisting device to the first user equipment, wherein the first SPS resource type does not overlap with the second SPS resource type.
11. The method of any previous embodiment, further comprising:
   receiving a broadcast/multicast/groupcast request from the first user equipment or the network node for providing assistance to the first user equipment in communicating with the network node.
12. The method of embodiment 10 further comprising:
   responsive to receiving the broadcast/multicast/groupcast request, transmitting one or more of the following to the first user equipment or the network node: a location of the first assisting device, a link quality between the first assisting device and the first user equipment, an identification of the first assisting device.
13. The method as claimed in any previous embodiment further comprising:
   responsive to the first assisting device moving to a location that does not meet a first criterion, transmitting an indication to the first user equipment or the network node that the first assisting device can no longer provide assistance to the first user equipment.
14. The method as claimed in any previous embodiment further comprising:
   responsive to receiving an indication from the first user equipment or the network node that the first assisting device can no longer provide assistance to the first user equipment, ceasing communication with the first user equipment.
15. The method of any previous embodiment wherein the first assisting device is one of: a relay device, an Integrated Access and Backhaul, IAB, a second user equipment, a repeater node, and a base station.
16. The method of any previous embodiment wherein the first user equipment comprises one of: an ambient Internet of Things, IoT, device and an ultra low power device
17. The method of any previous embodiment wherein the network node is one of is one of: a relay device, an Integrated Access and Backhaul, IAB, a second user equipment, a repeater node, and a base station.
18. The method of any of the previous embodiments, further comprising:
   obtaining user data; and
   forwarding the user data to a host or a user equipment.

### Group A2 Embodiments

19. A method performed by a first user equipment for communicating with a network node utilizing a first assisting device, the method comprising:
   receiving data from the first assisting device during a second time period in which the first user equipment is active, wherein the data was transmitted from the network node to the first assisting device during a first time period in which the first user equipment is inactive.
20. The method of embodiment 18 further comprising:
   transmitting an indication of the first time period and/or the second time period to the first assisting device or the network node.
21. The method of embodiment 19 or 20 further comprising:
   receiving data from the network node during the second time period.
22. The method of any one of embodiments 19 to 21 further comprising:
   transmitting a request for assistance in communicating with the network node to the network node and/or one or more candidate assisting devices.
23. The method of embodiment 22 further comprising:
   responsive to transmitting the request, receiving, for each of the one or more candidate assisting devices, information comprising one or more of: a location of the candidate assisting device, a link quality between the candidate assisting device and the first user equipment, an identification of the candidate assisting device.
24. The method of embodiment 23 wherein the information is received from one of: the one or more candidate assisting devices or the network node.
25. The method of embodiment 23 or 24 further comprising selecting the first assisting device from the one or more candidate assisting devices based on the information.
26. The method as claimed in any one of embodiments 19 to 25 further comprising:
   responsive to the first assisting device moving to a location that does not meet a first criterion, receiving an indication from the first user equipment or the network node that the first assisting device can no longer provide assistance to the first user equipment.
27. The method of any one of embodiments 19 to 26, further comprising:
   responsive to determining that a second assisting device is to be used, transmitting an indication to the first assisting device or the network node that the first assisting device can no longer provide assistance to the first user equipment.
28. The method of embodiment 27, further comprising, responsive to determining that a second assisting device is to be used, initiating a connection with the second assisting device.
29. The method of any one of embodiments 19 to 28, wherein the first assisting device is one of: a relay node, an Integrated Access and Backhaul, IAB, node a second user equipment, a repeater node, and a base station.
30. The method of any one of embodiments 19 to 29, wherein the first user equipment comprises one of: an ambient Internet of Things, IoT, device and an ultra low power device.
31. The method of any one of embodiments 19 to 30, wherein the network node is one of is one of: a relay device, an Integrated Access and Backhaul, IAB, node a second user equipment, a repeater node, and a base station.
32. The method of any of the previous embodiments, further comprising:
   providing user data; and
   forwarding the user data to a host via the transmission to the network node.

### Group B Embodiments

33. A method performed by a network node for communicating with a first user equipment using a first assisting device, the method comprising:
   transmitting data, to the first assisting device, intended for the first user equipment during a first time period during which the first user equipment is inactive.
34. The method of embodiment 33, further comprising:
   receiving an indication of the first time period and/or the second time period from the first user equipment.
35. The method of embodiment 34, further comprising:
   forwarding the indication of the first time period and/or the second time period to the first assisting device.
36. The method of embodiment 34 or 35, further comprising transmitting a configuration for an energy cycle to the first assisting device.
37. The method of embodiment 36 wherein the energy cycle comprises an active state during the first time period.
38. The method of embodiment 36 or 37, wherein the energy cycle comprises an inactive state for at least part of the second time period.
39. The method of embodiment 38 wherein the energy cycle comprises an active state for at least part of the second time period.
40. The method of any one of embodiments 33 to 39, wherein the one or more of:
The first assisting device has indicated to the network node that it has the capability to be used as an assisting device;
the first assisting device has low mobility;
the first assisting device is located in close proximity to the user equipment;
the first assisting device has a sufficient data buffering capacity to operate as an assisting device
the first assisting device is not fully occupied; and
the first assisting device has a constant or reliable power supply from the grid or a long battery life
41. The method of any one of embodiments 33 to 40, wherein the data is transmitted from the network node during a first semi-persistent scheduling, SPS, resource type for transmissions from the network node.
42. The method of any one of embodiments 33 to 41, further comprising:
   receiving a request from the first user equipment for providing assistance to the first user equipment in communicating with the network node.
43. The method of embodiment 42 further comprising:
   forwarding the request to one or more candidate assisting nodes comprising the first assisting node.
44. The method of embodiment 42 further comprising:
   responsive to forwarding the request, receiving, for each of the one or more candidate assisting devices, information comprising one or more of: a location of the candidate assisting device, a link quality between the candidate assisting device and the first user equipment, an identification of the candidate assisting device.
45. The method of embodiment 44 further comprising:
   forwarding the information to the first user equipment.
46. The method of embodiment 44 further comprising:
   selecting the first assisting device from the one or more candidate assisting devices based on the information, and indicating the first assisting device to the first user equipment.
47. The method as claimed in any one of embodiments 33 to 46 further comprising:
   responsive to the first assisting device moving to a location that does not meet a first criterion, receiving an indication form the first assisting device or the first user equipment that the first assisting device can no longer provide assistance to the first user equipment.
48. The method as claimed in any one of embodiments 33 to 47 further comprising:
   responsive to receiving an indication from the first user equipment or the first assisting device that the first assisting device can no longer provide assistance to the first user equipment, ceasing utilizing the first assisting device to communicate with the first user equipment.
49. The method of any one of embodiments 33 to 48 wherein the first assisting device is one of: relay, an Integrated Access and Backhaul, IAB, a second user equipment, a repeater node, and a base station.
50. The method of any one of embodiments 33 to 49 wherein the first user equipment comprises one of: an ambient Internet of Things, IoT, device and an ultra low power device.
51. The method of any one of embodiments 33 to 49 wherein the network node is one of is one of: a relay device, an Integrated Access and Backhaul, IAB, a second user equipment, a repeater node, and a base station.
52. The method of any of the previous embodiments, further comprising:
   obtaining user data; and
   forwarding the user data to a host or a user equipment.

### Group C Embodiments

53. A first user equipment, comprising:
   processing circuitry configured to cause the user equipment to perform any of the steps of any of the Group A2 embodiments; and
   power supply circuitry configured to supply power to the processing circuitry.
54. A network node, the network node comprising:
processing circuitry configured to cause the network node to perform any of the steps of any of the Group B embodiments;
power supply circuitry configured to supply power to the processing circuitry.
55. A first assisting device, comprising:
   processing circuitry configured to cause the user equipment to perform any of the steps of any of the Group A1 embodiments; and power supply circuitry configured to supply power to the processing circuitry.
56. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A2 embodiments;
   an input interface connected to the processing circuitry and configured to allow input of information into the UE to be processed by the processing circuitry; and
   an output interface connected to the processing circuitry and configured to output information from the UE that has been processed by the processing circuitry.
57. A first assisting device, the first assisting device comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A1 embodiments;
   an input interface connected to the processing circuitry and configured to allow input of information into the first assisting device to be processed by the processing circuitry;
   an output interface connected to the processing circuitry and configured to output information from the first assisting device that has been processed by the processing circuitry; and
   a battery connected to the processing circuitry and configured to supply power to the first assisting device.
58. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
59. the Host of the Previous Embodiment, Wherein:
   the processing circuitry of the host is configured to execute a host application that provides the user data; and
   the UE comprises processing circuitry configured to execute a client application associated with the host application to receive the transmission of user data from the host.
60. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.
61. The method of the previous embodiment, further comprising, at the network node, transmitting the user data provided by the host for the UE.
62. The method of any of the previous 2 embodiments, wherein the user data is provided at the host by executing a host application that interacts with a client application executing on the UE, the client application being associated with the host application.
63. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
64. The communication system of the previous embodiment, further comprising:
   the network node; and/or
   the UE.
65. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
66. The host of the previous 2 embodiments, wherein:
   the processing circuitry of the host is configured to execute a host application that receives the user data; and
   the host application is configured to interact with a client application executing on the UE, the client application being associated with the host application.
67. The host of the any of the previous 2 embodiments, wherein the initiating receipt of the user data comprises requesting the user data.
68. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
69. The method of the previous embodiment, further comprising at the network node, transmitting the received user data to the host.
70. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A2 embodiments to receive the user data from the host.
71. The host of the previous embodiment, wherein the cellular network further includes a network node configured to communicate with the UE to transmit the user data to the first UE from the host.
72. The host of the previous 2 embodiments, wherein:
   the processing circuitry of the host is configured to execute a host application, thereby providing the user data; and
   the host application is configured to interact with a client application executing on the UE, the client application being associated with the host application.
73. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A2 embodiments to receive the user data from the host.
74. The method of the previous embodiment, further comprising:
   at the host, executing a host application associated with a client application executing on the UE to receive the user data from the host application.
75. The method of the previous embodiment, further comprising:
   at the host, transmitting input data to the client application executing on the UE, the input data being provided by executing the host application,
   wherein the user data is provided by the client application in response to the input data from the host application.
76. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A2 embodiments to transmit the user data to the host.
77. The host of the previous embodiment, wherein the cellular network further includes a network node configured to communicate with the UE to transmit the user data from the UE to the host.
78. The host of the previous 2 embodiments, wherein:
   the processing circuitry of the host is configured to execute a host application, thereby providing the user data; and
   the host application is configured to interact with a client application executing on the UE, the client application being associated with the host application.
79. A method implemented by a host configured to operate in a communication system that further includes a network node and a user equipment (UE), the method comprising:
   at the host, receiving user data transmitted to the host via the network node by the UE, wherein the UE performs any of the steps of any of the Group A2 embodiments to transmit the user data to the host.
80. The method of the previous embodiment, further comprising:
   at the host, executing a host application associated with a client application executing on the UE to receive the user data from the UE.
81. The method of the previous 2 embodiments, further comprising:
   at the host, transmitting input data to the client application executing on the UE, the input data being provided by executing the host application,
   wherein the user data is provided by the client application in response to the input data from the host application.

1.-48. (canceled)

49. A method performed by a first user equipment for communicating with a network node via a first assisting device, the method comprising:
receiving data from the first assisting device during a second time period in which the first user equipment is active, wherein the data was transmitted from the network node to the first assisting device during a first time period in which the first user equipment is inactive.

50. The method of claim 49, further comprising transmitting an indication of the first time period and/or the second time period to the first assisting device or the network node.

51. The method of claim 49, further comprising receiving data from the network node during the second time period.

52. The method of claim 49, further comprising transmitting a request for assistance in communicating with the network node, wherein the request is transmitted to one or more of the following: the network node, and one or more candidate assisting devices.

53. The method of claim 52 further comprising, responsive to transmitting the request, receiving one or more of the following information for each of the one or more candidate assisting devices: a location of the candidate assisting device, a link quality between the candidate assisting device and the first user equipment, and an identification of the candidate assisting device.

54. The method of claim 53 wherein the information is received from one of the following: the one or more candidate assisting devices, or the network node.

55. The method of claim 53 further comprising selecting the first assisting device from the one or more candidate assisting devices based on the received information.

56. The method as claimed in claim 49 further comprising, responsive to the first assisting device moving to a location that does not meet a first criterion, receiving an indication that the first assisting device can no longer assist the first user equipment, wherein the indication is received from the first assisting device or the network node.

57. A method performed by a network node for communicating with a first user equipment via a first assisting device, the method comprising:
transmitting, to the first assisting device, data intended for the first user equipment, wherein the data is transmitted during a first time period in which the first user equipment is inactive.

58. The method of claim 57, further comprising receiving an indication of one or more of the following from the first user equipment: the first time period, and a second time period in which the first user equipment is active.

59. The method of claim 58, further comprising forwarding the indication to the first assisting device.

60. The method of claim 57, further comprising transmitting a configuration for an energy cycle to the first assisting device.

61. The method of claim 60 wherein the energy cycle comprises one or more of the following: an active state during the first time period, an inactive state for at least part of a second time period in which the first user equipment is active, and an active state for at least part of the second time period.

62. The method of claim 57, wherein the data is transmitted during one or more occasions of a first type of semi-persistent scheduling (SPS) resources configured for transmissions from the network node to the first assisting device.

63. A first user equipment configured to communicate with a network node via a first assisting device, wherein the first user equipment comprises processing circuitry and memory, wherein the memory stores instructions that, when executed by the processing circuitry, cause the first user equipment to:
receive data from the first assisting device during a second time period in which the first user equipment is active, wherein the data was transmitted from the network node to the first assisting device during a first time period in which the first user equipment is inactive.

64. The first user equipment of claim 63, wherein execution of the instructions by the processing circuitry further cause the first user equipment to:
transmit a request for assistance in communicating with the network node, wherein the request is transmitted to one or more of the following: the network node, and one or more candidate assisting devices;
receive one or more of the following information for each of the one or more candidate assisting devices: a location of the candidate assisting device, a link quality between the candidate assisting device and the first user equipment, and an identification of the candidate assisting device; and
select the first assisting device from the one or more candidate assisting devices based on the received information.

65. The first user equipment of claim 63, wherein execution of the instructions by the processing circuitry further cause the first user equipment to, responsive to the first assisting device moving to a location that does not meet a first criterion, receive an indication that the first assisting device can no longer assist the first user equipment, wherein the indication is received from the first assisting device or the network node.

66. A network node configured to communicate with a first user equipment via a first assisting device, wherein the network node comprises processing circuitry and memory, wherein the memory stores instructions that, when executed by the processing circuitry, cause the network node to:
transmit, to the first assisting device, data intended for the first user equipment, wherein the data is transmitted during a first time period in which the first user equipment is inactive.

67. The network node of claim 66, wherein execution of the instructions by the processing circuitry further cause the network node to:
receive an indication of one or more of the following from the first user equipment: the first time period, and a second time period in which the first user equipment is active; and
forward the indication to the first assisting device.

68. The network node of claim 66, wherein:
execution of the instructions by the processing circuitry further cause the network node to transmit a configuration for an energy cycle to the first assisting device; and
the energy cycle comprises one or more of the following: an active state during the first time period, an inactive state for at least part of a second time period in which the first user equipment is active, and an active state for at least part of the second time period.
